(19) United States
(12) Patent Application Publication
(10) Pub. No.: US 2020/0100458 A1
(43) Pub. Date: Apr. 2, 2020

(54) Methods and Systems for Efficient Milking of Cows

(71) Applicant: Don Gibson, Scottsbluff, NE (US)

(72) Inventor: Don Gibson, Scottsbluff, NE (US)

(21) Appl. No.: 16/585,942

(22) Filed: Sep. 27, 2019

Related U.S. Application Data
(60) Provisional application No. 62/737,619, filed on Sep. 27, 2018.

(51) Int. Cl. A01K 1/12; A01J 7/04; A01K 1/10

(52) U.S. Cl. CPC A01K 1/12; A01K 1/10; A01J 7/04

(57) ABSTRACT

Embodiments of the present invention may provide efficient milking of cows utilizing preparation, milking stations, and separate dipping stations with a continuous supply of feed each perhaps with the ability to clean and milk cows from underneath.

This is a U.S. Non-Provisional Patent Application claiming priority to and the benefit of U.S. Provisional Patent Application No. 62/737,619, filed Sep. 27, 2018, hereby incorporated by reference herein.

### BACKGROUND OF THE INVENTION

Cow milk is an important part of nutrition. As such, procedures for milking cows should be done in a clean and efficient manner. Embodiments of the present invention address the efficiencies of milking cows.

### SUMMARY OF THE INVENTION

Embodiments of the present invention may include multiple aspects that may operate in several ways and across various scales. Generally, they may relate to preparing cows for milking, and milking of cows. One aspect of the invention may include a preparation stall with a floor plan which may help to pre-prep cows prior to milking, which may help to keep a milking stall working more efficiently. Another object of the present invention may relate to the preparation stall being utilized in such a way as to help to keep the milking stall cleaner. In smaller cow numbers, it may be possible that one stall can serve as both the milking and the preparation stall.

Naturally, further objects, goals and embodiments of the inventions are disclosed throughout other areas of the specification, claims, and drawings.

### BRIEF DESCRIPTION OF THE DRAWINGS

FIG. 1 shows an example of a preparation station in accordance with some embodiments of the present invention.

FIG. 2 shows an example of a cow moving from a preparation station to a milking station in accordance with some embodiments of the present invention.

FIG. 3 shows an example of a milking station in accordance with some embodiments of the present invention.

FIG. 4 shows an example of a preparation station, milking station, and same supply of feed in accordance with some embodiments of the present invention.

FIG. 5 shows an example of a milking station with milking done below a cow in accordance with some embodiments of the present invention.

FIG. 6 shows an example of a cow exiting a milking station in accordance with some embodiments of the present invention.

FIG. 7 shows a conceptual drawing of a preparation, milking, and dipping stations with a same feed supply in accordance with some embodiments of the present invention.

### DETAILED DESCRIPTION OF THE INVENTIONS

As mentioned earlier, the present invention includes a variety of aspects, which may be combined in different ways. The following descriptions are provided to list elements and describe some of the embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. The specific embodiment or embodiments shown are examples only. The specification should be understood and is intended as supporting broad claims as well as each embodiment, and even claims where other embodiments may be excluded.

Importantly, disclosure of merely exemplary embodiments is not meant to limit the breadth of other more encompassing claims that may be made where such may be only one of several methods or embodiments which could be employed in a broader claim or the like. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

Embodiments of the present invention may provide a method for efficient milking of cows comprising the steps of providing a preparation station having a first continuous supply of feed in said preparation station; tempting a cow into said preparation station with said first continuous supply of said feed in said preparation station; securing said cow in said preparation station; allowing said cow to eat said continuous supply of feed in said preparation station; cleaning an udder of said cow in said preparation station; opening said preparation station when said cow has been cleaned in said preparation station; tempting said cow from said preparation station to a separate milking station with a second continuous supply of feed in said milking station; efficiently moving said cow from said preparation station to said milking station; securing said cow in said milking station; allowing said cow to eat said second continuous supply of feed in said milking station; and perhaps even milking said cow in said milking station.

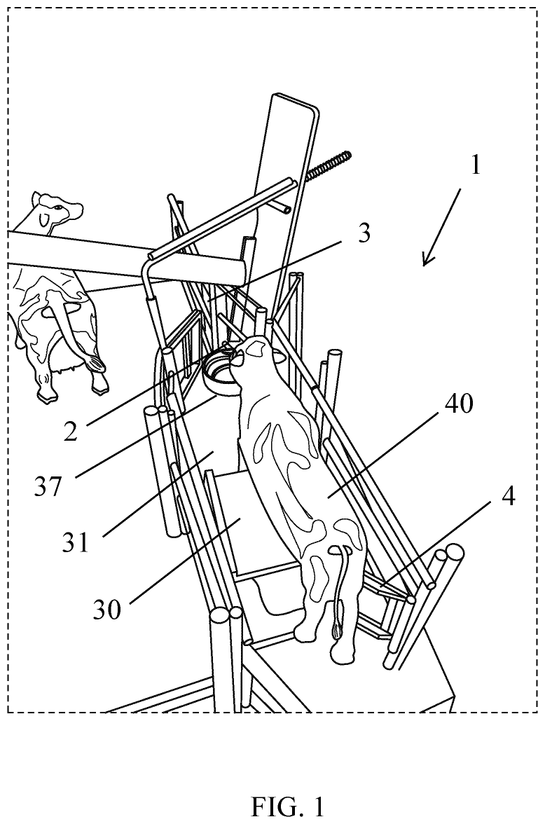

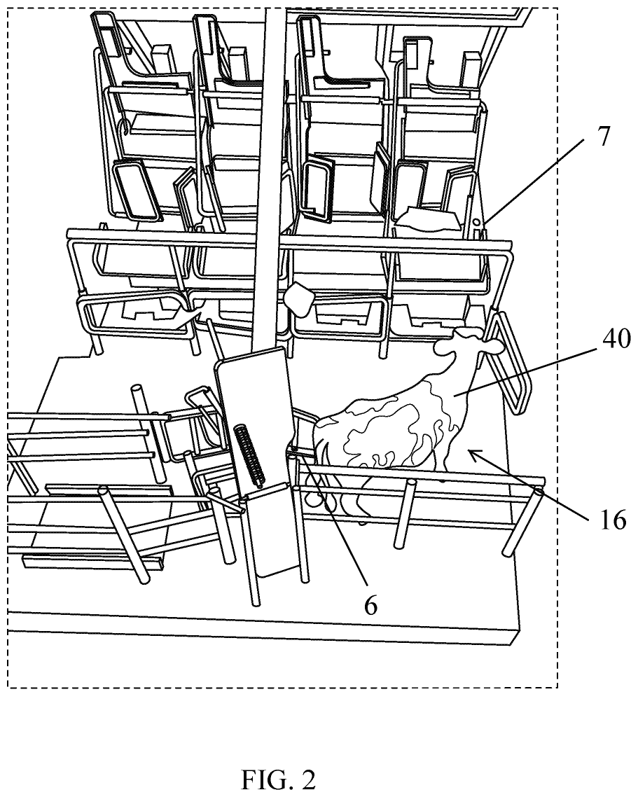

As may be understood in FIG. 1, a preparation station (1) may provide cleaning of a cow and her udder before milking. A preparation station may include a first continuous supply of feed (2). This feed may tempt a cow (40) into a preparation station. Once a cow may be in the preparation station, it may be secured perhaps with a head gate (3) and tail gate (4) each of which can be opened and closed. A tail gate may be closed behind a cow so that the next cow waiting her turn does not enter the preparation station. While the cow may be in a preparation station, it may eat the continuous supply of feed. The cow's udder (5) may be cleaned in the preparation station. As may be understood in FIG. 2, once cleaned, a preparation station may be opened (6) perhaps by opening a head gate (3) to allow a cow to move forward. A cow may be tempted from a preparation station to a separate milking station (7) perhaps with a second continuous supply of feed (8) in a milking station. Such second supply of feed may allow a cow to efficiently move from a preparation station to a milking station this may provide rapid advancing of a cow from a preparation station to a milking station. Once a cow may be in a milking station, it may be secured perhaps with a stanchion (10) and tail gate (11). A head gate (9) may be used also. While in a milking station, a cow may be allowed to eat a second continuous supply of feed and at the same time may be milked perhaps by attaching milking equipment (12) to a cow.

A cow may enter a preparation station through a back (15) of a preparation station and may exit (16) a preparation station from a front (14) of a preparation station. This may allow the cow to always move forward and avoid having to back up. A first continuous supply of feed may be located at a front (14) of a preparation station. A feed may be continuous so that there may always be feed in the preparation station. It may be slowly fed into the preparation station. While in the preparation station, the udder of a cow may be cleaned perhaps from an opening (30) in a floor (31) below the udder of a cow. Cleaning may include washing and drying of the udder.

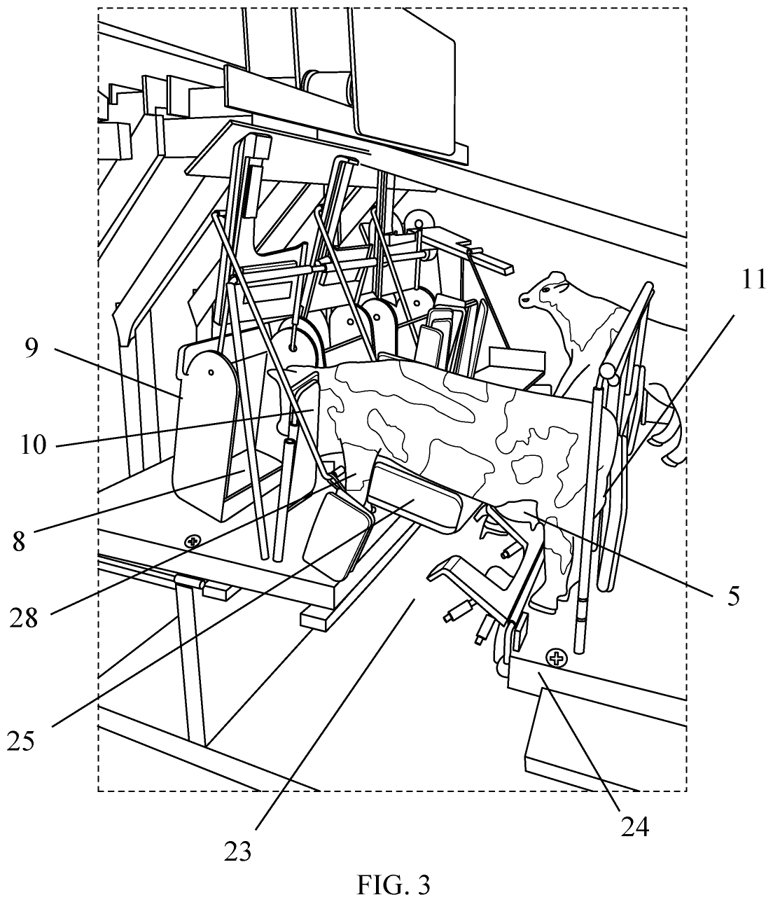

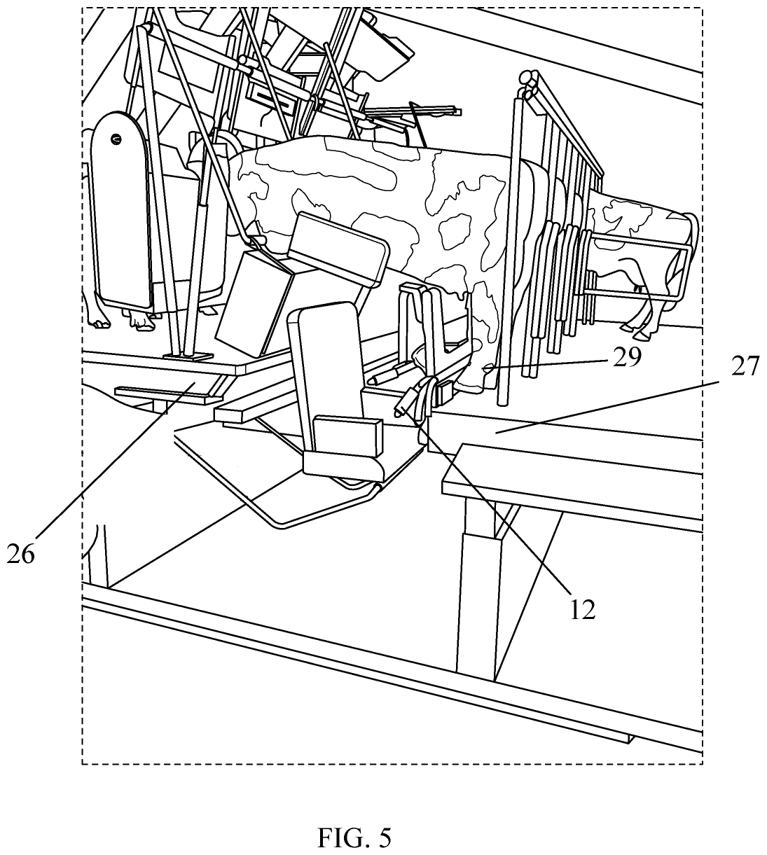

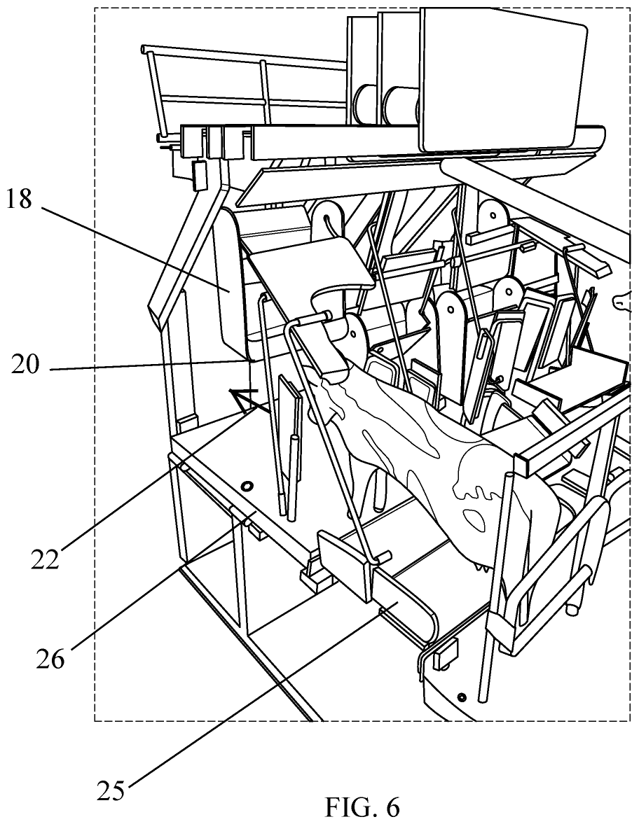

As may be understood in FIG. 3, a second continuous supply of feed (8) may be located at a front (19) of a milking station. Once milking may be complete, a second continuous supply of feed may be raised above (20) a cow and may allow a cow to exit (22) a milking station perhaps under the raised continuous supply of feed at a front of a milking station as shown in FIG. 6. A cow may be milked from an opening (23) in a floor (24) located below the udder (5) of a cow. A bridge (25) may be provided over the opening in the floor to allow the cow to move into the milking station. Once a cow may be secured in the milking station, the bridge may be raised so that an operator or even an automated system may attach milking equipment to a cow and begin milking the cow. As show in FIG. 5, a floor below a cow in a milking station, or even in a preparation station, may have a raised floor having a front floor (26) that may be higher than a back floor (27) perhaps so that when a cow may be standing in a milking station, the front feet (28) of a cow may be at a higher position than her back feet (29). This may allow easier placement of her udder for milking.

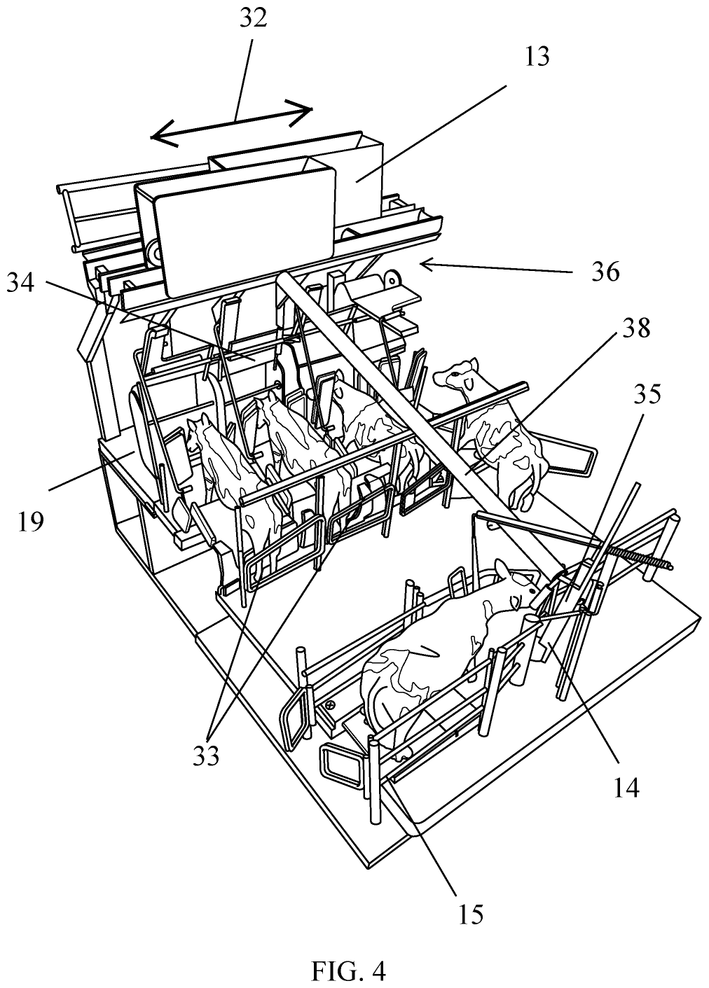

As may be understood in FIG. 4, a first continuous supply of feed in a preparation station and a second continuous supply of feed in a milking station may come from a same feed supply source (13). A same feed supply source may be located above (36) a milking station and may even be moved back and forth (32) above a plurality of adjacent of milking stations (33). A same feed supply source (13) may dispense feed, or even continuously dispense feed, to both a milking station (34) and to a preparation station (35). A same feed supply source may include containers of feed which can drop feed below into a container at a front of a milking station and may even supply feed from the containers to a container (37) in a preparation station. This may be done be releasing feed from the containers into a tube (38) which may be allow the feed to travel into a container in a preparation station. The feed may be provided to the preparation and milking stations perhaps based on the needs of each cow. In some embodiments, at least one preparation station may be provided for many milking stations such as but not limited to about three milking stations. Of course, this is but one example, and any number of milking stations may be provided per preparation station.

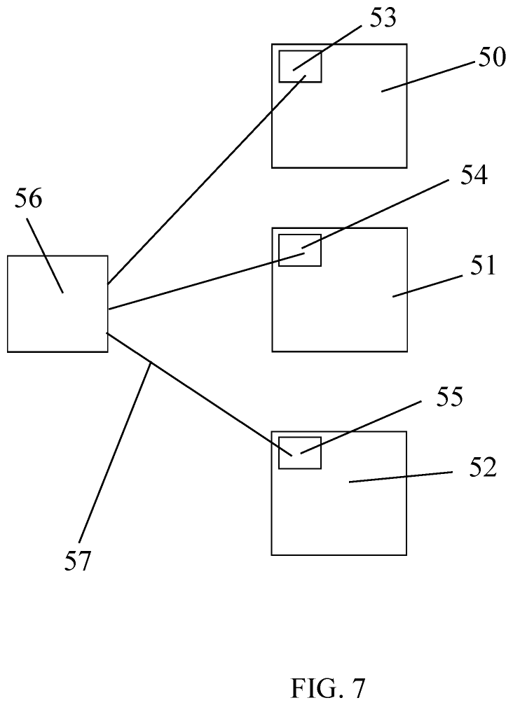

In some embodiments, the present invention may provide a dipping station which may be like a preparation station (1) but located separately after a cow has been milked and released from a milking station (7). Like a preparation station, a dipping station may have a head gate, tail gate and a stanchion. A third supply of feed may be provided in said dipping station. This third supply of feed may come from the same feed supply source perhaps like the preparation station. In a dipping station, a cow may be washed or its teats may be dipped while the cow may be eating from the third supply of feed. Once the cow may be done in the dipping station, the third supply of feed may be removed, and the head gate may be opened to allow the cow to advance forward and out of the dipping station. As but one example, the feed supplied in the stations may allow the cow to rapidly advance from one station to the next. After a cow may be done in a certain station, feed may be removed, the station may be opened and the cow may advance to the next station looking for feed. As may be understood in FIG. 7, a preparation stall (50) may provide a first continuous supply of feed (53) to a cow, a milking stall (51) may provide a second continuous supply of feed (54) to a cow, and a dipping stall (or station) (52) may provide a third continuous supply of feed (55) to a cow. Each supply of feed may be from a same feed supply source (56) where feed may be supplied (57) to each stall.

Various aspects of a milking stall as described herein may allow for a short downtime for re-loading an already-prepped incoming cow, once an already-milked cow may exit a stall. An entering cow may enter a milking stall from the preparation stalls, and may be kept in place by a stanchion which may be located in front of the cows shoulders, and a tail-gate, which may be located behind the cow. Once in place, a bridge (25) may open under the middle area of the cow, perhaps where an operator or robot may be able to access to the cow's udder and attach a milking apparatus. The opening may vary in size depending on the size front feet to back feet and or breed of the cow. The opening may also be equipped with cross splashing perhaps by a bridge splash shield and or even a kick shield. To ensure further safety, a bridge may automatically open, but not until the tailgate has been securely latched. Or, the bridge may be opened automatically when a cow may be latched in place once they are ready. Additional embodiments may only include an inclined stall and may not include an opening in the middle area of the cow.

In some embodiments, either with an opening in the middle of the cow, or even in those without such an opening, the floor of the stall may allow for the cow's back feet to be lower than the area under the cow's front feet, thus possibly effecting a cow situated in an incline, ready for milking. As but one example, a floor under the cow's front feet may be raised to be about 6 to about 10 inches above the back feet. Of course, any amount of incline may be used and all are meant to be included in this disclosure. The incline may help to make attaching the milking apparatus more accessible. In cows that have not already been prepped for milking, an incline may allow for cleaner preparation and even for cleaner milking. An inclined stance may keep the cow more stable during milking.

Once milking is complete, the releasing of the cow, which may occur either automatically or manually, may begin. This may begin with an automatic take off closing the bridge under the cow, then the head gate may release the stanchion, perhaps followed by the tailgate opening. A bridge may not close until the operator has fully exited the area under the cow. Once these steps have been completed, the cow may exit the milking stall, and the next, already-prepped cow may enter to be milked. The walk-through nature of both the preparation and the milking stalls may allow the milking process to be more efficient.

In another embodiment, a preparation stall may look similar to the milking stall as described above. Prep stalls may be fully automated such that the opening of the floor under the middle area of the cow may be utilized by an operator to wash and dry the cow's teats prior to milking. Embodiments may also include a floor drain to discard liquids. An inclined floor plan for prepping may make the prepping easier than a flat floor operator or automation.

Preparation stalls may also include an apparatus to collect udder information, including but not limited to, teat location from laser locators, and may send such information to the milking stall. The milking stall may utilize an automatic, robotic milking attachment (as opposed to a manual milking attachment), which may use the received information to have the milking attachment ready for the cow upon entering.

Below the stalls that utilize the opening in the middle of the cow, embodiments of the present invention may attach a rail to utilize a robotic or manual attached seat, on which an operator may sit in order to attach the milking attachment. The seat may be, for example, hydraulic or electric and may be able to move up and down, left and right, or even forward and backward. In embodiments with multiple stalls, the move-able, hydraulic seat may be able to maneuver across all of the stalls, thus possibly allowing the operator to easily attach a milking attachment to many cows in a short amount of time. Attachment of milking equipment from this seat may be easily done. An attacher may be limited to the amount of stalls since the stalls may automatically close and reload for the attacher to be back to reattach. Each stall may be reattached about every 6 or about 7 minutes. In another embodiment, the system could have an adjustment for each attached platform for standing to accomplish the milking attachment, rather than a seat for sitting and to help attach in bad conditions.

Some embodiments, perhaps those that include multiple stalls, may include switches which may keep the stalls milking cows in a synchronized fashion. In a larger herd, it may be possible to operate many milking stalls at once. With this system, the milk from each teat could be viewed before it mixes with other milk. In some embodiments, a milk pipe-line could be utilized for calves', lower-quality, treated milk, or the like. One quarter of the milk can be kept apart from other three quarters without slowing down the output number of the stall.

Feeding during preparation or milking may be very important. The cows may enter more rapidly for the grain. With a feed box and even a head gate incorporated in a walk-through stall, all cows can exit. In a milking station, a feedbox may receive feed at all times perhaps when it is raised or even lowered. A head gate may serve as a wall on both sides, perhaps when it may be up and when the exiting cow goes under. An entering cow may be stopped by the stanchion and a feed box may come down. A single training stall perhaps with stanchion and even a feed box could be placed in heifer lot perhaps with a small grain amount each time she goes through. Embodiments of the present invention may provide a device to train heifers with a step up in training stall before she becomes a cow with small treat for entering.

A preparation stall may have a small amount of feed at all times coming from a same feed supply source such as a grain cart located over a milking stall. A slow-moving auger may be provided and a cow may enter a prep stall. A stanchion may go from an enter position to a stop. A tailgate may lock, a bridge may open perhaps over a kick shield. When a cow may enter a prep stall, she may make an inclined step up with her front feet, only her back feet remain on the lower level; perhaps making her udder more accessible. There may be an apparatus present to protect the cow from coming into contact with the kick shield. After prepping, a kick shield may go down and a bridge may lower for the cow to walk over, as the head gate may open and feed box may be removed. When a cow may exit a prep stall, her back feet may step up on the inclined level perhaps as the stanchion may open for a walk-through stall. A head gate may open and a feed box may be removed.

When a cow may exit the stanchion, it may go back to the enter position for the entering cow. The head gate may close and a feed box may come back with feed perhaps receiving in slow mode. One prep stall may be provided for each 10 milk stalls or more depending on conditions. A prepped cow may go to open milking stall. She may step up to enter the inclined milking stall perhaps where the stanchion may be in an enter position and may stop the cow as the tailgate may latch the head gate and a feeder may come down while feed dribbles perhaps in at all times. With cow in place, the bridge under a cow may open up behind the front legs and under her. The bridge may bend depending on the breed of cows in the herd. A kick shield may come up with milking unit. An inclined stall may be designed for the operators to go back and forth attaching in about 10 to about 12 stalls. Robots may be provided to attach more than one stall.

After the cow may be milked, its teats may be dipped, and perhaps the unit may be removed as the kick shield may fold down with the unit. A tailgate may latch. Milk hoses may be shorter to the milk pipeline. The bridge may then come down on top of kick shield. The stanchion may open for the cow to exit perhaps under the head gate and under a feed box. As a cow may pass through stanchion, it may go back to an enter position for the next cow to enter. When the feed box is up, it may still be receiving dribbled feed.

Feed carts may be located above the milking stalls. Carts may go back and forth dribbling small amounts of feed in each feed box and prep stall tube. The carts may be loaded at each end of parlor. Carts may be capable of providing feed to about fifty to about one hundred stalls perhaps with two tracks filling at both ends of the parlor. A clam shell that may be pre-weighed could drop the return load as the cart goes back to be reloaded at the other end. Splash shields may be provided as dividers between milking stalls. The shields may be ribbed plastic or the like perhaps to guide cows.

The floor of the parlor may be a double rebar perhaps for strength. The supporting walls can be adjusted as needed for space for manual labor or robot or the like. A bridge material may have high strength aluminum bars perhaps covered with traction plating and may even use stainless steel hinges. The weight of the bridge can be offset by using the weight of the head gate and feed box.

The prepping stall bridge could be one piece without a bend. The bend in the bridge may give more room for the preparation equipment. A training stall out in the heifer lot could help get her ready for the time she becomes a milk cow. Training, perhaps in the form of standing at an inclined position, can start as a young calf, perhaps even still bucket-fed or even still milk-fed. Training stalls may be placed between corrals so that it may provide an experience similar to that of a milking stall. The training stall may help to engrain in calves the knowledge that there is feed in the stalls, perhaps getting them used to, and comfortable in, milking or training stalls.

The present invention may provide in various embodiments, a milking system where cows can be easily and efficiently brought into a milking system including a preparation station which may include cleaning, washing, stimulating, or the like, and then once prepared, the cow may move to a milking stall. A system may be designed so that the cows may walk forward through the preparation and milking stall. They may not have to be backed out of the milking station. Once the milking may be completed, the cows may leave the milking stall by walking forward out of the station. There may be any amount of milking stalls and preparation stations as desired in a system. In one example, about 100 milking stalls may be provided and for every 10 milking stalls, a preparation station may be provided. Of course, any number of stations may be used.

In embodiments of the present invention, feed may be provided to the cows in the washing station. Feed may flow from a feed supply, which may removable for exit, perhaps from elevated carts and may even flow downhill from a feed supply perhaps into a removable tub. As a non-limiting example, feed may be transported in a tube. This may be an auger brushing feed down or a tube which may have brushes or even fibers that can turn perhaps to push the feed through. Gravity may also help the feed flow from feed supply to the feed container. The tube may be made of plastic, steel, or the like. Feed may be slowly added to a feed container, perhaps as a dribble to entice the cows to enter the washing station and to stay while being prepared for milking. Of course, feed may be provided to a preparation station by any supply including automated, manually, or the like. The stanchion may hold the cow in the preparation stall.

A feed supply may be added to elevated carts which may be located above the milking stall. There may be one, two, three, or more elevated carts on separate tracks or on the same tracks and they may move along the tracks above the milking stall. The feed supply may be added to the elevated carts perhaps via a clamshell-type device. This type of device may be used as it may provide for only the amount of feed desired, and may allow for the cart to travel back across the same number of stalls as it traveled forward to. The elevated carts may be adjustable in size, width, placement, or the like. The carts may be located above the milking feeder containers in the milking stall. For each milking feeder container, an amount of feed may be placed or even dropped into the milking feeder container. The amount may be adjusted to any amount and may be adjusted based on the specifications and needs of the individual cow. In one non-limiting example, about one pound of feed may be received in each milking feeder container. A walkway may be provided near the elevated carts perhaps to allow access to the elevated carts. The elevated carts may be electrically, motorized, manually, or the like, in operation. In embodiments of the present invention, there may be two elevated carts which may move back and forth to drop feed in up to about 100 milking feeder containers.

In the various stations (milking, preparation, or the like), there may be a gate to enter and perhaps even a gate to exit the station. A gate may be a single panel, may be a double panel, a panel that may open horizontally perhaps in one or more directions, a panel that may open vertically perhaps in one or more directions, a panel that may open horizontally and vertically perhaps in one or more directions, or the like. Perhaps any of the gates may be capable of receiving a cow, stopping a cow or opening for a cow to pass, any combination thereof, or the like.

A cow may enter a preparation station through an enter gate which may open before the cow enters and may close when a cow may be in the preparation station. An exit gate may be closed when the cow may be entering the preparation station and may open when the cow may be ready to leave the preparation station. A kick shield may be positioned in front of the cow's back legs perhaps to prevent the cow from kicking forward to the preparation area. Part of a floor under the cow of preparation station may be opened, perhaps so that an operator or even a robot may prepare the cow for the milking stall. During the preparation, the cow may eat feed that may be supplied to a feed container in the preparation station. Once the cow may have completed the preparations, the feed may be gone and perhaps the cow may exit the preparation station through the exit gate and may proceed to a milking stall. An exit gate may open so as to guide the cow to the appropriate milking stall.

At a milking stall, there may be a enter gate to a milk stall which may open before the cow may enter. A cow may enter the milking stall where her front feet are at a position that may be higher than her back feet. A cow may be enticed to enter the milking stall perhaps by providing feed in the milking stall. A feed container may be provided perhaps as part of the milking stall's head gate which may act to feed the cow and may provide an exit gate. The feed box and gate may be movable, perhaps up-and-down. Once a cow may enter a milking stall, the front gate may close behind the cow and perhaps a back gate, which may allow the cow's head to pass, may be closed to stop the cow from proceeding ahead. The cow may be allowed to eat the feed in the feed container during milking. Part of a floor under the cow of milking stall may be opened, perhaps so that an operator or even a robot may attach milking devices perhaps from under the cow. A kick shield may be placed, perhaps opened, in front of the cow's back feet perhaps to prevent the cow from kicking the operator, robot, or milking devices. The feed container at a front of the milking stall may be mechanically connected to the openable flooring perhaps so that when the floor opens up under the cow, the feed container may lower and the cow may begin to eat the feed at the back side of the head gate of the milking stall. In some embodiments, the movement of the floor may be connected to the movement of the feeding containers so that the opening and closing of the floor and feeding container may be done at the same time and using the weight of the other to assist in the opening or closing or the like. The weight of the feeder may be adjusted to the weight of the openable floor section. Hydraulics may even be used in opening and closing the floor, gates, lowering and raising the feed container, or the like. A splash shield may be located perhaps at the sides of the openable floor of the milking stall. These may help guide the cow into the milking stall and may even prevent the cow from entering an adjacent milking stall. The splash shields may also prevent splashing of urine and any other waste from one station to another and may be adjusted to a desired height and length. After a cow may exit a station, a floor cleaner may be used to clean up any waste. The stanchion stops the cow making the box and gate come down and latches the back and opens the bridge and brings up the kick shield and unit.

Once the cow may be done with milking, the floor may be lowered, the feeding container may be raised and perhaps even a back gate may open. The cow may then exit the milking stall and may be directed to exit the milking system perhaps while a new cow enters the milking stall. This system may allow for the prep stalls to prep 10 to 12 cows in approximately seven minutes, which may allow for 12 milks stalls to be filled.

In some embodiments, an operator may be under the cows to attach the milking devices. The operator may fit under the opened floor and may be capable of moving under the milking stalls to attach or detach milking devices. The opened floor may protect the operator from the cow, getting splashed. It may take about 6 to about 7 minutes, or more or less, to milk a cow. A system may provide that about one preparation stall can be used for up to about 12 milking stalls or more. Of course, the system may vary so that any number of stations may be used. The system may be computerized perhaps where each cow may be tracked and may even be optimized as desired.

In embodiments of the present invention, it may be desirable to have a preparation station and feeder in the yard of the dairy perhaps to train the cows in the preparation station. It is noted that the preparation stations and exit paths for the milking stalls may be in any desirable placement such as, but not limited to parallel, perpendicular, sideways, angular, circular, or the like with respect to the milking stalls. In embodiments, various milking lines, hot water heaters, vacuum pumps, sewage lines, milk lines, or the like may be located under the floor of the preparation and even milking stalls perhaps where an operator or even robots may have access thereof.

In some embodiments, a milking station may have about a 10 inch incline. It may have a head gate, a stanchion, and even a tail gate. An exit floor may be about four feet and may be sloped to a drain. There may be an opening bridge perhaps providing about 42 inches of an opening and maybe about 32 inches for smaller breeds. An entrance floor may be sloped to drain. Weight bearing walls may be placed under an exit and entrance floor and near a milking operator. The walls may be placed as needed for space. A rail may be provided under an exit floor perhaps for an operator or a robot. Walls may be pierced for strength and may be tied to milking floors. Water lines, air conditioners, and even vacuum pumps may be located below a still floor. Under the stall floor may be an operator floor. A robot or even a manual hydraulic caged seat may move back and forth under cows standing side by side. Stalls may open and close from the automatic take off. A walk through stall may reload which may make is possible to keep all units continuously milking. A floor of a stall may be down for exiting and entering. Cows may be prewashed and dried before entering. Perhaps with manual attaching all stalls can be operating. Robots may have to be able to attach in more than one stall. Manual attachers could be able to attach ten cows or more.

A milking floor may open after a tail gate may be closed. Attachment is made. Automatic take off closes the floor and opens the head gate and stanchion. Replacement cows may come in and start the process over. A seated or standing attacher may move back and forth attaching prewashed replacements. The floor of the milking station may be made of rebar or even double rebar. It may have a floor drain. All milking equipment may be kept on a lower level when not being used. There may be sufficient room for robot equipment on a lower level. A lower level may include extra milk pipe lines perhaps for calf milk. A stall can be used without a robot. Large herds could be milked in less time with about 100 stalls.

In some embodiments, over about 100 cows may be processed perhaps up to three times a day. Research can be done on two or three stalls. A first stall may be used for breaking heifers where an operator can be the side. A robot milking system may be used with between one and two stalls up to three times a day. For example, up to about 1300 cows may be milked in about 8 hours using about about 20 stalls and even up to about 2600 cows can be milked using about 40 stalls in about 8 hours. A cow milking time may be about 20 minutes if she is milked three times a day. This can be used with large or even small herds. If about four stalls are used, then about 256 cows can be milked in about eight hours. For two stalls, about 160 cows can be milked in about eight hours. A system can be expanded as needed. Wash stalls may be placed near the milking stalls, perhaps even about four wash stalls may be used with about 15 milking stall system.

A preparation stall, perhaps even an inclined preparation stall, may keep the milking stalls working all the time with almost no down time. Preparation stalls may help keep the milking stalls clean. A preparation stall may have an incline which may bring the udder forward for better prepping opening a bridge under the cow or not prepping from both sides or under. A milking stall perhaps an inclined milking stall may be designed to keep all units milking. It may only take a short time to reload the stall when the cow exits through and a new cows enters. A stall may open under a cow when the stanchion may click which may cause a tail gate to close. A very slow feed drop may begin which may keep a cow's attention. The attachment of the milking device may take place. An automatic take off may start the closing of the bridge, opening of a headgate, release of a stanchion, and opens the tailgate for the next cow.

An incline may be any amount of incline that makes the attaching and prepping more accessible. An incline stance may keep a cow more stable. Cows can be prepped in an inclined milk stall but with larger herds an inclined prep stall may keep all the units milking. An eight inch step may make four fifth of the incline the other two inches of the incline may be in the bridge that covers an opening of the stall floor. A station and tail gate may be needed to keep a cow in place and stable. A walk through stall may be efficient. Switches may keep stalls synchronized. About ten switches may be used in the milking stalls and about seven for the prepping stalls. The bridge may not close until an operator is finished. With this system, the milk from each teat could be viewed before it is mixed with other milk. A milk pipe line may be used for low quality or even treated milk.

When it is time to switch out cows from a milking station, a switch may start the synchronization to the bridge to close, the head gate and stanchion to open as the cow moves through the tail gate, opens the head gate, springs back latching the entire cow moves through the tail gate that latches behind her which latches the stanchion. Now the cow is unable to move forward or backward. This allows a bridge to open bring in a milking unit up for attaching. Feed may be dropped into a feeder when a head gate is latched. An operator may be used to latch the milking equipment.

A floor opening can vary from small cows to larger cows and there may be plenty of room for an attacher or even robot attaching. An incline for small cows can be less, perhaps a bridge may be shorter. A cow may have her front feet about 6 to about 10 inches above her back feet.

For a preparation stall, a floor plan may provide an opening in the floor perhaps with an incline. There may not be a need for operator space in a prep stall as it may be automated. Prepping equipment can be done from either side or the floor can be opening for prepping. Prepping equipment cam be attached to the under side of a bridge or a kick shield or the like.

Embodiments of the present invention may provide the ability to milk as many cows in eight hours per unit. Large herds may be milked three times a day. Each unit may be milking nearly all the time. Smaller herds may reduce a milking time. Cleanliness may be provided since milking may be done from a cleanest side of the udder.

As can be easily understood from the foregoing, the basic concepts of the present invention may be embodied in a variety of ways. It involves both preparation and milking techniques as well as devices to accomplish the appropriate preparation and milking. In this application, the preparation and or milking techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included for the device described, but also method or process claims may be included to address the functions the invention and each element performs. Neither the description nor the terminology is intended to limit the scope of the claims that will be included in any subsequent patent application.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the invention both independently and as an overall system.

Further, each of the various elements of the invention and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “container” should be understood to encompass disclosure of the act of “containing”—whether explicitly discussed or not—and, conversely, were there effectively disclosure of the act of “containing”, such a disclosure should be understood to encompass disclosure of a “container” and even a “means for containing”. Such changes and alternative terms are to be understood to be explicitly included in the description. Further, each such means (whether explicitly so described or not) should be understood as encompassing all elements that can perform the given function, and all descriptions of elements that perform a described function should be understood as a non-limiting example of means for performing that function.

Any acts of law, statutes, regulations, or rules mentioned in this application for patent; or patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the information disclosure statement or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to have support to claim and make a statement of invention to at least: i) each of the devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) an apparatus for performing the methods described herein comprising means for performing the steps, xii) the various combinations and permutations of each of the elements disclosed, xiii) each potentially dependent claim or concept as a dependency on each and every one of the independent claims or concepts presented, and xiv) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like. As one clarifying example, if a claim were dependent “on claim 20 or any other claim” or the like, it could be re-drafted as dependent on claim 1, claim 15, or even claim 25 (if such were to exist) if desired and still fall with the disclosure. It should be understood that this phrase also provides support for any combination of elements in the claims and even incorporates any desired proper antecedent basis for certain claim combinations such as with combinations of method, apparatus, process, and the like claims.

Finally, any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

What is claimed is:

1. A method for efficient milking of cows comprising the steps of:
providing a preparation station having a first continuous supply of feed in said preparation station;
tempting a cow into said preparation station with said first continuous supply of said feed in said preparation station;
securing said cow in said preparation station;
allowing said cow to eat said continuous supply of feed in said preparation station;
cleaning an udder of said cow in said preparation station;
opening said preparation station when said cow has been cleaned in said preparation station;
tempting said cow from said preparation station to a separate milking station with a second continuous supply of feed in said milking station;
efficiently moving said cow from said preparation station to said milking station;
securing said cow in said milking station;
allowing said cow to eat said second continuous supply of feed in said milking station; and
milking said cow in said milking station.

2. The method for efficient milking of cows as described in claim 1 and further comprising a step of providing said first continuous supply of feed to said preparation station and said second continuous supply of feed to said milking station from a same feed supply source.

3. The method for efficient milking of cows as described in claim 1 wherein said first continuous supply of feed is located at a front of said preparation station.

4. The method for efficient milking of cows as described in claim 1 and further comprising a step of allowing said cow to enter said preparation station through a back of said preparation station.

5. The method for efficient milking of cows as described in claim 1 and further comprising the steps of removing said second continuous supply of feed in said milking station and allowing said cow to exit said preparation station from a front of said preparation station.

6. The method for efficient milking of cows as described in claim 1 and further comprising a step of removing said second continuous supply of feed in said milking station once said cow has been milked.

7. The method for efficient milking of cows as described in claim 1 and further comprising the steps of:
providing said second continuous supply of feed at a front of said milking station;
raising said second continuous supply of feed above said cow after said step of milking is done; and
allowing said cow to exit said milking station under said raised continuous supply of feed at said front of said milking station.

8. The method for efficient milking of cows as described in claim 1 wherein said step of milking said cow in said milking station comprises the step of milking said cow from an opening in a floor below udder of said cow.

9. The method for efficient milking of cows as described in claim 8 and further comprising a step of providing an openable bridge over said opening in said floor.

10. The method for efficient milking of cows as described in claim 8 wherein said floor below said cow in said milking station comprises a raised floor having a front floor that is higher than a back floor to provide when a cow is standing in said milking station, front feet of said cow are higher than back feet of said cow.

11. The method for efficient milking of cows as described in claim 1 wherein said step of cleaning said udder of said cow in said preparation station comprises the step of cleaning said udder of said cow in said preparation station from an opening in a floor below udder of said cow said preparation station.

12. The method for efficient milking of cows as described in claim 2 and further comprising the steps of:
moving said same feed supply source back and forth above a plurality of adjacent of milking stations; and
dispensing feed from said same feed supply source to said milking station and to said preparation station.

13. The method for efficient milking of cows as described in claim 12 wherein said step of dispensing feed from said same feed supply source to said milking station and to said preparation station comprises a step of continuously dispensing feed from said same feed supply source to said milking station and to said preparation station.

14. The method for efficient milking of cows as described in claim 2 and further comprising the steps of:
locating said same feed supply source above said milking station; and
feeding feed from said feed supply source to a container in said preparation station.

15. The method for efficient milking of cows as described in claim 2 wherein said step of providing said first and second continuous supply of feed to said preparation station and said milking station from a same feed supply source comprises the step of providing said feed based on the needs of each cow.

16. The method for efficient milking of cows as described in claim 12 and further comprising the steps of:
opening said milking station after said cow has been milked;
tempting said cow into a dipping station with a third continuous supply of feed in said dipping station;
securing said cow in said dipping station;
allowing said cow to eat said third continuous supply of feed in said dipping station; and
washing teats of said cow in said dipping station.

17. The method for efficient milking of cows as described in claim 1 and further comprising the step of providing at least one preparation station per at least about three milking stations.

18. The method for efficient milking of cows as described in claim 16 and further comprising a step of dispensing feed from said same feed supply source to said dipping station.

19. The method for efficient milking of cows as described in claim 18 wherein said step of dispensing said feed from said same feed supply source to said milking station and to said preparation station and to said dipping station comprises the step of dispensing feed from said same feed supply to said preparation station and said dipping station with a tube.

20. The method for efficient milking of cows as described in claim 1 wherein said step of cleaning an udder of said cow in said preparation station comprises the step of washing and drying said udder of said cow in said preparation station.
